(19) United States
(12) Patent Application Publication
(10) Pub. No.: US 2015/0095117 A1
(43) Pub. Date: Apr. 2, 2015

(54) MANAGING KEY PERFORMANCE INDICATORS

(71) Applicant: International Business Machines Corporation, Armonk, NY (US)

(72) Inventors: Rajaraman Hariharan, Sunnyvale (CA); Jegan Jegadeesan, Chennai (IN); Dattatreya S. Vellal, Bangalore (IN); Vignesh Velusamy Ravindran, Chennai (IN)

(73) Assignee: International Business Machines Corporation, Armonk, NY (US)

(21) Appl. No.: 14/041,603

(22) Filed: Sep. 30, 2013

(51) Int. Cl. G06Q 10/06

(52) U.S. Cl. CPC G06Q 10/06393
USPC 705/7.39

(57) ABSTRACT

A computer manages methods for calculating key performance indicators by receiving, a plurality of key performance indicators for an activity measure, wherein each key performance indicator is associated with a key performance indicator method. Determining, a corresponding confidence level for each of the plurality of key performance indicators. Identifying, an ideal key performance indicator based on the confidence level for each of the plurality of key performance indicators. Receiving a request, from an application, for information pertaining to the activity measure, wherein the request includes one or more application parameters related to the requested information.

### FIELD OF THE INVENTION

The present invention relates generally to key performance indicators, and more particularly, to managing key performance indicators value and methods.

### BACKGROUND OF THE INVENTION

Key Performance Indicators (KPIs) are a type of performance measurement which an organization can use to evaluate overall success or to evaluate the success of a particular activity in the organization. Typically, success is defined in terms of making progress towards strategic goals, but often success is a repeated achievement of some level of operational goals. Typically, various KPI methods can be used to generate a particular sought-after KPI value. However, the KPI methods do not necessarily produce the same KPI value due to the variables associated with each KPI method, such as time and available resources needed to perform each KPI method.

For example, in the field of healthcare, blood glucose level can be a KPI of a patient's health. The blood glucose level of the patient can be determined using an instant test with a portable personal blood glucose testing device. Alternatively, the blood glucose level of the patient can be determined through other testing methods in laboratories. The instant testing device and laboratory testing methods both produce a KPI value (i.e., blood glucose level), but the confidence level of the KPI value using the instant testing device is typically lower than the confidence level of the KPI value using laboratory testing methods. However, laboratory testing methods are typically more expensive and more time consuming than using an instant testing device. Identifying which KPI method is ideal to use based on the particular needs of the organization is not transparent since each KPI method has its own benefits. Therefore, the organization has to be able to identify which KPI method or KPI methods are likely to yield the sought-after desirable results for future generation of KPI values.

### SUMMARY

Embodiments of the present invention disclose a method, computer program product and computer system for calculating key performance indicators. A computer receives, by one or more processors, a plurality of key performance indicators for an activity measure, wherein each key performance indicator is associated with a key performance indicator method. The computer determines, by one or more processors, a corresponding confidence level for each of the plurality of key performance indicators. The computer identifies, by one or more processors, an ideal key performance indicator based on the confidence level for each of the plurality of key performance indicators. The computer receives a request, from an application, for information pertaining to the activity measure, wherein the request includes one or more application parameters related to the requested information.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of a KPI analysis program utilizing a time compensator and a confidence calculator for determining KPI values and a corresponding confidence level for each of the determined KPI values, in accordance with an embodiment of the present invention.

FIG. 3 is a flowchart depicting operational steps of a KPI analysis program utilizing a KPI selector for determining an ideal KPI value based on the corresponding confidence levels, in accordance with an embodiment of the present invention.

FIG. 4 is a flowchart depicting operational steps of a KPI analysis program utilizing a KPI optimizer for determining an ideal KPI method based on received application parameters, in accordance with an embodiment of the present invention.

FIG. 5 is a block diagram of components of a computer system, such as the computer server of FIG. 1, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable media having computer readable program code/instructions embodied thereon.

Any combination of computer-readable media may be utilized. Computer-readable media may be a computer-readable signal medium or a computer-readable storage medium. A computer-readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

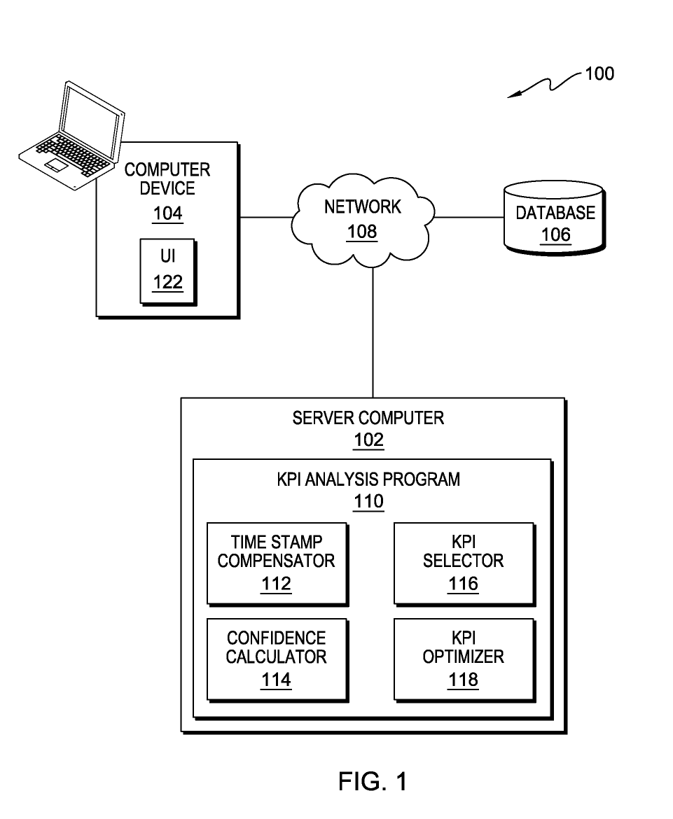

FIG. 1 is a functional block diagram illustrating a distributed data processing environment, generally designated 100, in accordance with one embodiment of the present invention. Distributed data processing environment 100 includes server computer 102, computer device 104, and database 106 interconnected over network 108.

Server computer 102 may be a desktop computer, a laptop computer, a tablet computer, a specialized computer server, a smartphone, or any other computer system known in the art. In certain embodiments, server computer 102 represents a computer system utilizing clustered computers and components that act as a single pool of seamless resources when accessed through network 108, as is common in data centers and with cloud computing applications. In general, server computer 102 is representative of any programmable electronic device or combination of programmable electronic devices capable of executing machine-readable program instructions and communicating with other computer devices via a network. In this embodiment, server computer 102 has the ability to communicate with other computer devices to query the computer devices for information.

Key Performance Indicator (KPI) analysis program 110 residing in computer server 102 has the ability to determine confidence levels of KPI values based on the methods utilized to achieve said KPI values. Utilizing the determined confidence level of each KPI value, KPI analysis program 110 has the ability to recommend a KPI value. KPI analysis program 110 can also receive parameters from an application, for example, a business application, and recommend a KPI method to use based on previously calculated KPI values and corresponding KPI confidence levels. KPI analysis program 110 may comprise functions or tools such as time stamp compensator 112, confidence calculator 114, KPI selector 116, and KPI optimizer 118.

Time stamp compensator 112 can analyze two or more time intervals for data sets used by multiple KPI methods to determine KPI values, to determine if there is comparable data in the two or more time intervals. Time stamp compensator 112 takes into account the different time intervals and adjusts any difference between the different times intervals so a direct comparison of the data sets can be performed by confidence calculator 114. Time stamp compensator 112 compensates for any inaccuracies since using data points from different time intervals to determine KPI values may produce inaccurate confidence levels for each of the determined KPI values.

Confidence calculator 114 determines a confidence level for each of the determined KPI values corresponding to each of the different KPI methods. KPI analysis program 110 utilizes confidence calculator 114 to compare various KPI values corresponding to KPI methods to determine the relative accuracy of each KPI value. KPI analysis program 110 infers patterns of variation in each KPI value and stores the patterns of variation in the form of a confidence level for each KPI value corresponding to a KPI method.

KPI selector 116 determines an ideal KPI value based on the confidence level of each of the KPI values. KPI selector 116 is a function of KPI analysis program 110 and can be user programmed to provide an ideal KPI value or multiple ideal KPI values based on the respective confidence levels. KPI selector 116 also has the ability to provide additional context around the confidence level of the KPI value as to why the said KPI value is ideal.

KPI optimizer 118 determines an ideal KPI method based on received application parameters. KPI optimizer 118 can receive the application parameter via network 108 from a user of computer device 104 or any other computer device connected to network 108 (not shown). KPI optimizer 118 is a function of KPI analysis program 110 and can provide the most suitable KPI method along with the corresponding KPI value and confidence level in the form of a recommendation to the user of KPI analysis program 110.

In general, network 108 can be any combination of connections and protocols that will support communications between server computer 102, computer device 104 and database 106. Network 108 can include, for example, a local area network (LAN), a wide area network (WAN) such as the internet, a cellular network, or any combination of the preceding, and can further include wired, wireless, and/or fiber optic connections.

In one embodiment, KPI analysis program 110 may be a web service accessible via network 108 to a user of a separate device, e.g., computer device 104. In another embodiment, KPI analysis program 110 may be operated directly by a user of server computer 102.

User interface 122 on computer device 104 displays information that any one of the processes of KPI analysis program 110 may display to a user. User interface 122 can be, for example, a graphical user interface (GUI) or a web user interface (WUI) and can display text, documents, web browser windows, user options, application interfaces and instructions for operation. In various embodiments of the present invention, computer device 104 can be a laptop computer, a tablet computer, a netbook computer, a personal computer (PC), a desktop computer, a personal digital assistant (PDA), a smartphone, or any programmable electronic device capable of communicating with server computer 102 and database 106 via network 108.

Database 106 can store content of KPI analysis program 110 such as, KPI values and confidence levels for corresponding KPI methods for each business measure. Database 106 can have a directory accessible by a user of computer device 104 or KPI analysis program 110 on server computer 102. Database 106 can also be located on server computer 102, computer device 104, or any other location in distributed data processing environment 100 connected to network 108.

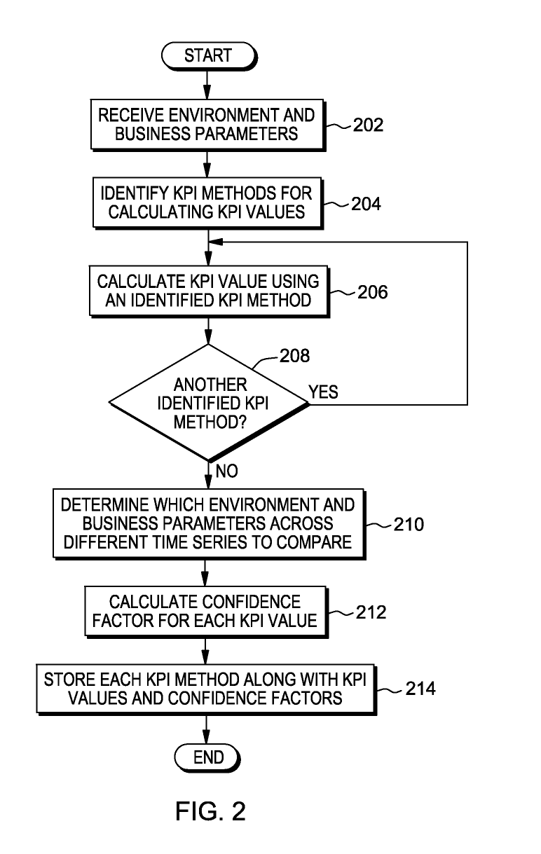

FIG. 2 is a flowchart depicting operational steps of KPI analysis program 110 utilizing time stamp compensator 112 and confidence calculator 114 for determining KPI values and a corresponding confidence level for each of the determined KPI values, in accordance with an embodiment of the present invention.

KPI analysis program 110 receives environment and business parameters (step 202). In one embodiment, KPI analysis program 110 can query an external computer device, such as computer device 104, to send the environment and business parameters for which KPI analysis program 110 calculates KPI values through various possible KPI methods. The user of computer device 104 can specify which environment and business parameters to send to KPI analysis program 110 via user interface 122. In another embodiment, KPI analysis program 110 can query database 106 to send the environment and business parameters. In one embodiment, KPI analysis program 110 calculates a KPI value through KPI methods where each KPI value is a person's overall health status based on a blood glucose level reading of the person. In this example, environment parameters can include any form of data relating to the calculation of the person's blood glucose level, such as types of meals prior to the blood being drawn from the person or where the blood is drawn from the person. Business parameters include constraints on the environment parameters rather than the actual data which is used for calculating the person's blood glucose level, for example the sample size of the person's blood or the time the blood was drawn from the person. KPI analysis program 110 can receive environment and business parameters that are historical, current or a combination of both. Such a variation of historical and current parameters allows for KPI analysis program 110 to establish time intervals for which KPI values are calculated using the various KPI methods.

KPI analysis program 110 identifies KPI methods for calculating KPI values (step 204). KPI analysis program 110 can receive the KPI methods from a user input determining the various methods being utilized. Since not all KPI methods are calculation based, there are situations where a KPI method requires experimentation to obtain a KPI value. Continuing from the previous example of determining a person's blood glucose levels, an example KPI method can utilize a portable personal blood glucose testing device. Such a portable personal blood glucose testing device can receive a sample of a person's blood, analyze it and produce a blood glucose level in a timely manner. In another example of a KPI method, a blood glucose level of the person is sampled and is experimentally determined at a laboratory facility. Both KPI methods can obtain the KPI values (i.e., blood glucose level), but the degree of accuracy and the time needed for each KPI method differs.

KPI analysis program 110 calculates a KPI value using an identified KPI method (step 206). KPI analysis program 110 selects a KPI method and determines if the KPI value can be calculated or if the user has to manually determine the KPI value and input the KPI for the corresponding KPI method. In an exemplary embodiment, KPI analysis program 110 selects a KPI method where it can calculate the KPI value, and KPI analysis program 110 calculates the KPI values according to the environment and business parameters. In various other embodiments, KPI analysis program 110 can select a KPI method where it cannot calculate the KPI value, and KPI analysis program 110 can query the user through user interface 122 on computer device 104 to determine what the KPI value is for that particular KPI method. KPI analysis program 110 stores the KPI value for the corresponding KPI method.

KPI analysis program 110 determines if there is another identified KPI method for calculating a KPI value (decision 208). In the event KPI analysis program 110 determines there is another KPI method for calculating a KPI value (yes branch, decision 208), KPI analysis program 110 reverts back to step 206 to calculate the KPI value using the other KPI method. In another embodiment, KPI analysis program 110 can determine to calculate the KPI value using the other KPI method during certain instances. For example, KPI analysis program 110 can determine to utilize the other KPI method on certain days of the week or certain hours of the day depending on the implementation of KPI analysis program 110. A user can program such determinations of when particular KPI methods are utilized by KPI analysis program 110 as user preferences. In the event KPI analysis program 110 determines there is no other identified KPI method for calculating a KPI value (no branch, decision 208), KPI analysis program 110 determines if the KPI values corresponding to the various KPI methods are comparable across different time intervals.

KPI analysis program 110 determines which environment and business parameter data sets across different time intervals are comparable (step 210). KPI analysis program 110 can utilize a time compensator tool, for example, time stamp compensator 112, which is capable of taking two or more time intervals for data sets and determining data points across the two or more time intervals that are comparable. In another embodiment, the determination of data points across two or more intervals that are comparable can be a function of KPI analysis program 110. Such a determination allows for direct comparison between the data points without the possibility of variation due to time. Continuing from the previously mentioned example, if a blood sample utilized by a first KPI method is from Monday and another blood sample utilized by second KPI method is from Friday, KPI analysis program 110 can determine the two KPI methods are not comparable since the data used to calculate the KPI values are from two distinctly different time intervals. However, if both blood samples for the first KPI method and the second KPI method are from Friday, KPI analysis program 110 can determine the time interval for the data points to be comparable.

KPI analysis program 110 compares data sets for comparable time intervals to reduce bias in confidence levels for each KPI value. However, even though KPI analysis program 110 can determine a time interval with comparable data points for two or more KPI methods, certain data points can be absent for particular time points in the time interval. For example, in a data set for a first KPI method you have the following values, ((t1,v1), (t2,v2), (t3,null), (t4,v4)) and in a data set for a second KPI method you have the following values, ((t1,w1), (t2,null), (t3,w3), (t4,w4)). The “t#” stamp represents a time point in a time interval of the data, the “v#” and “w#” stamps represent the data for the corresponding “t#”, and “null” represents the absences of data. KPI analysis program 110 can determine values for “v1” and “w1” are comparable as well as values for “v4” and “w4.” However, KPI analysis program 110 can not determine comparable values for “v2” and “w2”, or values for “v3” and “w3” because “v3” and “w2” are absent.

KPI analysis program 110 can compensate for non-comparable values by utilizing a distance function. KPI analysis program 110 can compare values for the “t2” time point, “v2” and “w2” against either values for the “t1” time point or the “t3” time point. KPI analysis program 110 can determine that “t1” time point is closer to “t2” time point than “t3” time point is to “t2” time point. So, KPI analysis program 110 determines “t2” values of “v2” and “w2” are comparable to “t1” values of “v1” and “w1.” However, even with KPI analysis program 110 pairing “t2” values with “t1”, comparison between “t1” and “t2” is not possible due to the possibility of inaccuracies the different time points cause. KPI analysis program 110 can extrapolate the values for “t2” using the data from “t1” and “t3.” If extrapolation is not possible, KPI analysis program 110 determines to utilize only “t1” values and “t4” values for calculating the confidence levels.

KPI analysis program 110 calculates a confidence factor for each determined KPI method (step 212). KPI analysis program 110 can utilize an algorithm based tool for calculating the KPI confidence levels, such as confidence calculator 114. Confidence calculator 114 can have multiple algorithms, where each algorithm represents a possible KPI method for calculating a KPI confidence level. In another embodiment, a function of KPI analysis program 110 can include the multiple algorithms for the KPI methods rather than a separate calculating tool. KPI analysis program 110 filters the KPI methods by identifying possible KPI methods to correlate based on any similar techniques utilized in the various KPI methods. In one embodiment, the correlation between the KPI methods is the deviation of a KPI value of a particular KPI method from the average value of all the available KPI values corresponding to the KPI methods. KPI analysis program 110 calculates deviations from the correlations for each of the KPI methods and identifies patterns between environment factors and the confidence levels of the KPI methods utilized to calculate KPI values. In one embodiment, KPI analysis program 110 utilizes a correlation method where a correlation is established for the KPI values to determine the deviation from the correlation for each of the KPI values. KPI analysis program 110 calculates the deviation between the two KPI values at a particular time value as a function of the difference between the corresponding two KPI values from the different data corresponding to each of the KPI methods. The further the deviation from the correlation, the lower the confidence level of the KPI value and the corresponding KPI method. Similarly, the closer the deviation from the correlation, the higher the confidence level of the KPI method and the corresponding KPI factor.

In another embodiment, KPI analysis program 110 can utilize a statistical or clustering technique between the calculated correlation deviations for each KPI value and any set factors affect accuracy of a given KPI method. Set factors can include input parameters and environment factors relating to each KPI calculation. KPI analysis program 110 is able to statistically identify patterns of factors with the data set behind each KPI value thus inferring the confidence level for each KPI value. When utilizing a cluster technique, KPI analysis program 110 is able to have multiple confidence levels for multiple time intervals of a single KPI value. For example, KPI analysis program 110 calculates a KPI confidence level to be 90% for a motor efficiency KPI value when the current (i.e., amperage) ranges from 12 A to 15 A and the voltage is between 440V to 450V. However, KPI analysis program 110 can calculate a confidence level to be 92% for the current range from 17 amps to 20 amps and the voltage is between 440V to 450V. KPI analysis program 110 has the ability to calculate multiple confidence levels based on user specified constraints.

KPI analysis program 110 stores each KPI method along with the corresponding KPI value and confidence factor (step 214). KPI analysis program 110 can store the KPI values and confidence factors for each corresponding KPI method in an external database, for example, database 106. The external database can store and receive updated KPI values accordingly. For example, if KPI methods for corresponding KPI values and confidence levels exist in the database, KPI analysis program 110 can query the user whether or not to store the new KPI values along with the already stored KPI values or to replace the already stored KPI values with the new KPI values.

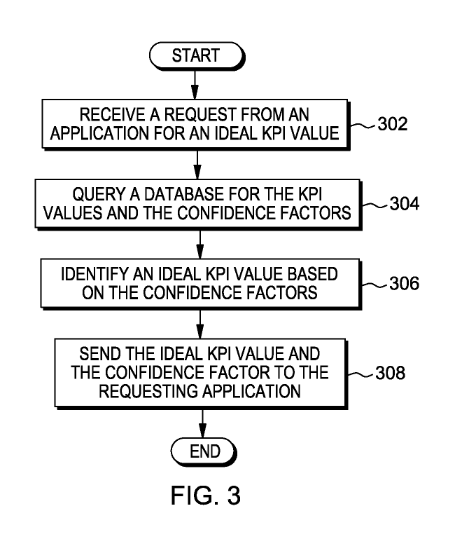

FIG. 3 is a flowchart depicting operational steps of KPI analysis program 110 utilizing KPI selector 116 for determining an ideal KPI value based on corresponding confidence factor, in accordance with an embodiment of the present invention.

KPI analysis program 110 may receive a request from an application or a user via a user interface, such as user interface 122 on computer device 104, for an ideal KPI value pertaining to a specific activity measure based on the calculated confidence level for each of the KPI values. KPI analysis program 110 can access a database, such as database 106, to obtain the KPI values and a confidence level or multiple confidence levels for each of the KPI values. Based on the confidence level of each KPI value, KPI analysis program 110 can identify the ideal KPI value and the associated KPI method and send the information to the requesting application or user.

KPI analysis program 110 receives a request from an application for an ideal KPI value (step 302). KPI analysis program 110 can store various KPI values relating to a specific activity measure, also referred to as a business measure, such as the previously mentioned example of a person's health based on the blood glucose level of, in database 106. The directory can also have multiple business measures which KPI analysis program 110 manages along with the various KPI values and confidence levels for each of the multiple business measures. In one embodiment, the application can be a secondary program requesting an ideal KPI value for a particular business measure. In another embodiment, KPI analysis program 110 receives the request from a user through a user interface. KPI analysis program 110 can display the directory of each business measure and the user can select the specific business measure for which KPI analysis program 110 determines the ideal KPI value based on the confidence level.

KPI analysis program 110 queries a database for the KPI values and the confidence levels (step 304). In one embodiment, KPI analysis program 110 can query a database, for example, database 106, for all the KPI values and confidence levels for all the corresponding KPI methods for the particular business measure selected in step 302. In addition, depending on the received request, KPI analysis program 110 can query the database for a particular time interval for which the KPI values were calculated. For example, KPI analysis program 110 can query the database for KPI values and confidence levels for a particular hour of the day for factory production measures. The database can store factory production measures as KPI values for every hour of a given day. However, the application requesting the ideal KPI value is for the noon hour of a given day and KPI analysis program 110 has the ability to query the database for KPI values and confidence levels for that particular time point.

KPI analysis program 110 identifies an ideal KPI value based on the corresponding confidence level for each KPI value (step 306). KPI analysis program 110 can utilize a KPI value selector tool, for example, KPI selector 116 to select an ideal KPI value depending on the request previously mentioned in the discussion of step 302. In another embodiment, selecting an ideal KPI value can be a function of KPI analysis program 110 rather than a separate selecting tool. KPI analysis program 110 receives the KPI values, along with the confidence levels for each of the KPI values associated with a KPI method. In one embodiment, KPI analysis program 110 can rank the KPI values according to the confidence levels for each of the KPI values. The higher the confidence level, the more ideal the KPI value and the associated KPI method for the KPI value. KPI analysis program 110 can select the KPI value with the highest confidence level and designate the selected KPI value as the most ideal. In another embodiment, KPI analysis program 110 can have a user established threshold for the confidence level. If a KPI value has a confidence level below the threshold, KPI analysis program 110 determines the KPI value and the associated KPI method as not being ideal. If a KPI value has a confidence level above the threshold, KPI analysis program 110 determines the KPI value and the associated KPI method ideal and adds the KPI value to a list which KPI analysis program 110 can send to the requesting application. The list can contain the KPI values with confidence levels that are above the confidence level threshold corresponding to a single business measure.

KPI analysis program 110 also has the ability to manage multiple confidence levels for each KPI value associated with a KPI method. For example, if a KPI value was obtained with the value of 120 ppm blood glucose reading using an associated KPI method, the confidence levels can vary depending on the time interval of the reading (i.e., time of day). If KPI analysis program 110 obtains a KPI value by the associated KPI method at 8:00 AM, the confidence level for that particular time point is 87%. However, if KPI analysis program 110 obtains the same KPI value by the same associated KPI method at 8:00 PM, the confidence level for that particular time point is 95%. Such a variation in confidence level for different time intervals can be accounted for due to the variation in the environment factors for those different time intervals. KPI analysis program 110 can have the ability to take into account the different confidence levels for each KPI value. In one embodiment, KPI analysis program 110 can average the two confidence levels and assign the average (i.e., 91%) as the overall confidence level for that particular KPI value associated with a KPI method. In another embodiment, KPI analysis program 110 can provide both confidence levels for the KPI value by prompting a message in the user interface for the user to view. KPI analysis program 110 can receive an input from the user specifying which confidence level to utilize when determining the ideal KPI value based on the confidence level for the associated KPI method.

KPI analysis program 110 sends the ideal KPI value and the confidence level to the requesting application (step 308). In one embodiment, if the secondary program requests the ideal KPI value for a particular business measure, KPI analysis program 110 can send the ideal KPI value and the confidence level to the requesting secondary program via a network, for example, network 108. Depending on the user preference, KPI analysis program 110 can send the ideal KPI value and the confidence level or a list of the KPI values ranked from most ideal to least ideal. In another embodiment, KPI analysis program 110 can display the ideal KPI value and the confidence level in a user interface for the user to view. In the user interface, KPI analysis program 110 can provide the user an option to view the ideal KPI value along with the list of all the available KPI values ranked from most ideal to least ideal.

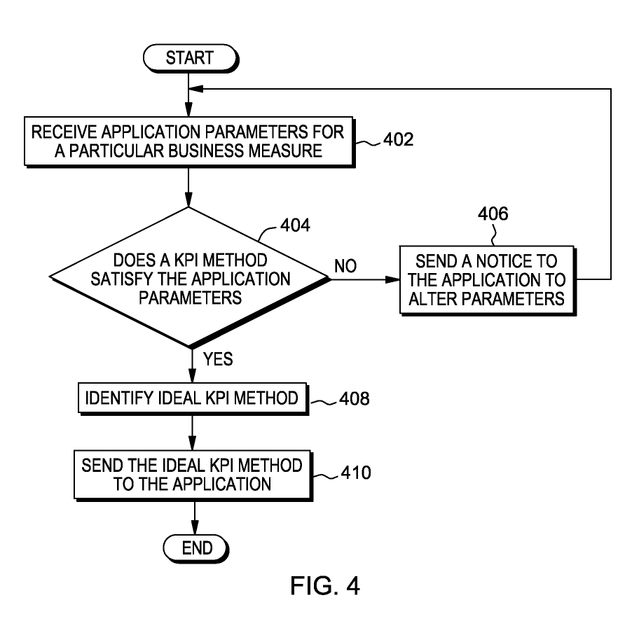

FIG. 4 is a flowchart depicting operational steps of KPI analysis program 110 utilizing KPI optimizer 118 for determining an ideal KPI method based on received application parameters, in accordance with an embodiment of the present invention.

Another function of KPI analysis program 110 is the ability to identify an ideal KPI method for obtaining a KPI value for a particular business measure. KPI analysis program 110 can receive application parameters, for example, business application parameters, for the particular business measure which allows KPI analysis program 110 to identify possible KPI methods, as well as reduce the list of possible KPI methods which do not meet the application parameters. KPI analysis program 110 can identify an overall ideal KPI method for the particular business measure, as well as multiple ideal KPI methods if there is a certain KPI method that is more ideal than another for a particular application parameter, such as for a particular time period.

KPI analysis program 110 receives application parameters for a particular business measure (step 402). In one embodiment, a secondary program sends the application parameters to KPI analysis program 110. In another embodiment, a user utilizing a user interface can send the application parameters to KPI analysis program 110. The particular business measure specifies what the KPI values and associated KPI methods are directed towards. An example of a particular business measure can be a person's health based on the person's blood glucose level. An example of an application parameter is a confidence level constraint for the KPI values. KPI analysis program 110 can determine if there is a KPI method associated with a KPI value which produces KPI values that have confidence levels above a certain threshold (e.g., 90%). If a KPI value does not satisfy the threshold, the associated KPI method is not nominated for being a possible ideal KPI method. If a KPI value does meet the threshold, the associated KPI method is nominated for being a possible ideal KPI method.

Another example of an application parameter is the amount of time a KPI method takes in calculating an associated KPI value and confidence level. Returning to the previously mentioned example of obtaining a KPI value for a person's health based on blood glucose levels, there are a few known KPI methods for obtaining the KPI values. The first KPI method uses a portable personal blood glucose testing device, which is a KPI method typically needing little time to obtain the KPI value. The second KPI method performs laboratory testing which typically needs an extensive amount of time to obtain the KPI value. Another example of an application parameter is the amount of resources needed to perform the KPI method. For example, a portable personal blood glucose testing device is relatively easy to obtain, so KPI analysis program 110 can deem the amount of resources needed for this particular KPI method as low. A laboratory facility to test a person's blood for blood glucose levels is relatively hard to obtain, so KPI analysis program 110 may deem the amount of resources needed for this particular KPI method as high.

KPI analysis program 110 determines if there is a KPI method that satisfies the received application parameters (decision 404). In the event that KPI analysis program 110 determines there is a KPI method that satisfies the application parameters (“yes” branch, decision 404), KPI analysis program 110 determines which of the KPI methods that satisfy the application parameters is most ideal. In the event that KPI analysis program 110 determines there is no KPI method that satisfies the application parameters (“no” branch, decision step 404), KPI analysis program 110 requests the application parameters be altered.

KPI analysis program 110 sends a notice to the application to alter the parameters (step 406). In one embodiment, KPI analysis program 110 can send the secondary program a notice specifying the application parameters have not been met and to alter said application parameters. Similarly, in another embodiment, KPI analysis program 110 can send the user via the user interface a notice to alter the application parameters. The notice can contain a list of the KPI methods identified for the particular business measure and KPI analysis program 110 can identify which KPI method did not meet which application parameter. For example, KPI method “KPIx1” failed to meet the time constraint and the resource application parameter and KPI method “KPIx2” failed to meet the time constraint and the confidence level threshold application parameter. Based on the notification containing which application parameters were not met, KPI analysis program 110 can receive application parameters, as in step 402 and determine if the altered application parameters yield any possible ideal KPI methods.

KPI analysis program 110 identifies the ideal KPI method out of the KPI methods that best satisfy the received application parameters (step 408). KPI analysis program 110 can utilize a KPI method selector tool, such as KPI optimizer 118 to select an ideal KPI method based on the received application parameters previously mentioned in the discussion of step 402. In another embodiment, selecting an ideal KPI method can be a function of KPI analysis program 110. KPI analysis program 110 can identify each KPI method which satisfies the application parameters as ideal. Since the KPI methods meet the application parameters; KPI analysis program 110 can deem the KPI methods as ideal and possible methods for future calculation of KPI values. In another embodiment, KPI analysis program 110 selects the KPI method that most satisfies a particular application parameter. For example, there are two application parameters which KPI methods have to satisfy, such as a minimum 90% confidence level and a time calculation limit. KPI analysis program 110 determines there are multiple KPI methods that satisfy both parameters. However, KPI analysis program 110 includes a user preference to assign more importance to confidence level deviation over time calculation deviation. As a result, the KPI method which KPI analysis program 110 identifies as the ideal KPI method is the KPI method capable of achieving the greatest deviation from the confidence level, thus also having the highest confidence level. If KPI analysis program 110 includes a user preference to assign more importance to time calculation deviation over confidence level deviation, KPI analysis program 110 identifies the KPI method that requires the least amount of time to calculate a KPI value.

KPI analysis program 110 can also identify multiple ideal KPI methods given different time intervals or business parameters. For example, KPI analysis program 110 can determine a first KPI method is ideal for the morning hour's time interval while a second KPI method is ideal for the evening hour's time interval. In another example, KPI analysis program 110 identifies the business parameters to contain a current range of 12 A to 20 A used to calculate the KPI value. KPI analysis program 110 can identify a first KPI method as being ideal for calculating KPI values for currents in the range of 12 amps to 15 amps and a second KPI method as being ideal for calculating KPI values for current in the range of 16 amps to 20 amps.

KPI analysis program 110 sends the ideal KPI method to the requesting application (step 410). KPI analysis program 110 can send the ideal KPI method or methods along with the associated KPI value and confidence level to the secondary program which originally sent the application parameters to KPI analysis program 110 in step 402. In another embodiment, a secondary program sends the application parameters to KPI analysis program 110. In another embodiment, a user utilizing a user interface, for example, user interface 122, can send the application parameters to KPI analysis program 110 and KPI analysis program 110 can send the ideal KPI method or methods to the user utilizing the user interface which originally sent the application parameters to KPI analysis program 110.

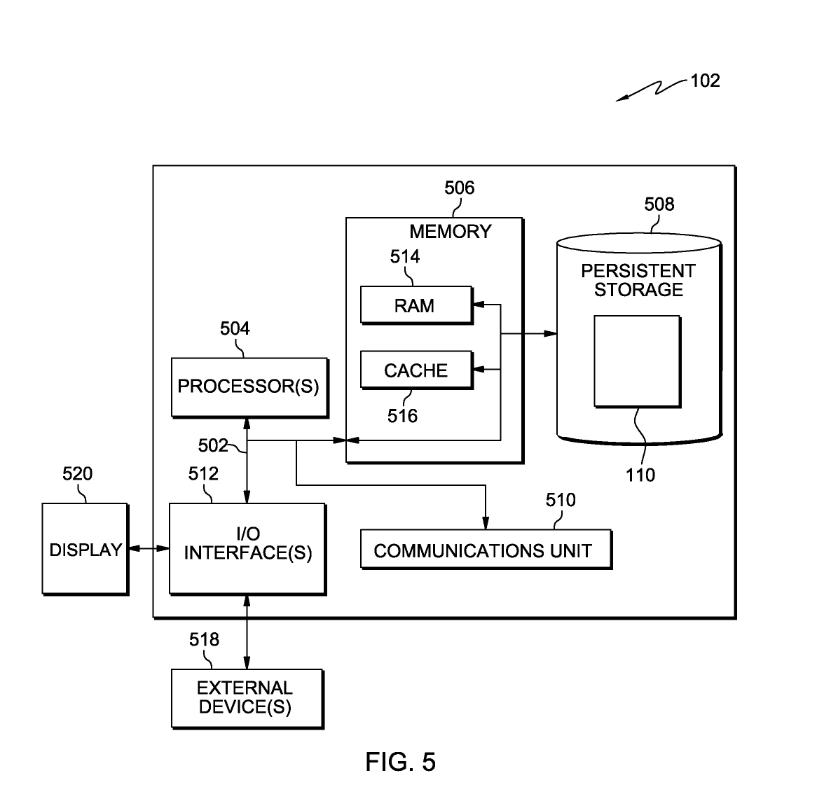

FIG. 5 depicts a block diagram of components of a computer, such as server computer 102, operating KPI analysis program 110 along with component functions, time stamp compensator 112, confidence calculator 114, KPI selector 116, and KPI optimizer 118 within distributed data processing environment 100, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Server computer 102 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage medium.

KPI analysis program 110 stored in persistent storage 508 for execution by one or more of computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage medium that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including systems and devices within or controlled by server computer 102. In these examples, communications unit 510 includes one or more wireless network interface cards. Communications unit 510 may provide communications through the use of either or both physical and wireless communications links. Computer programs and processes, such as KPI analysis program 110, may be downloaded to persistent storage 508 through communications unit 510, or uploaded to another system through communications unit 510.

I/O interface(s) 512 allows for input and output of data with other devices that may be connected to server computer 102. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 508 via I/O interface(s) 512. I/O interface(s) 512 may also connect to a display 520.

Display 520 provides a mechanism to display data to a user and may be, for example, a touch screen or a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1-7. (canceled)

8. A computer program product for managing methods for calculating key performance indicators, the computer program product comprising:
one or more computer readable storage media;
program instructions stored on the one or more computer readable storage media, which when executed by one or more processors, to:
receive, by one or more processors, a plurality of key performance indicators for an activity measure, wherein each key performance indicator is associated with a key performance indicator method;
determine, by one or more processors, a corresponding confidence level for each of the plurality of key performance indicators;
identify, by one or more processors, an ideal key performance indicator based on the confidence level for each of the plurality of key performance indicators; and
receive a request, from an application, for information pertaining to the activity measure, wherein the request includes one or more application parameters related to the requested information.

9. The computer program product of claim 8, further comprising program instructions, stored on the one or more computer readable storage media, which when executed by a processor, to:
identify, by one or more processors, the requested information is the ideal key performance indicator pertaining to the activity measure; and
sending, by one or more processors, the ideal key performance indicator and the determined corresponding confidence level to the requesting application.

10. The computer program product of claim 8, further comprising program instructions, stored on the one or more computer readable storage media, which when executed by a processor, to:
identify, by one or more processors, the requested information is an ideal key performance indicator method associated with the ideal key performance indicator; and
sending, by one or more processors, the ideal key performance indicator method associated with the ideal key performance indicator.

11. The computer program product of claim 9, wherein the one or more application parameters related to the requested information include a minimum threshold value for the confidence level for each key performance indicator.

12. The computer program product of claim 10, wherein the one or more application parameters related to the requested information includes one or more of: an amount of time needed to calculate a key performance indicator, an amount of resources needed to calculate each key performance indicator, or a minimum threshold value for the confidence level of each key performance indicator.

13. The computer program product of claim 11, wherein sending the ideal key performance indicator and the determined confidence level to the requesting application, comprises program instructions, stored on the one or more computer readable storage media, which when executed by a processor, to:
determine, by one or more processors, two or more key performance indicators meet the one or more application parameters; and
sending, by one or more processors, the two or more key performance indicators with the determined confidence level for each of the two or more key performance indicators, wherein the ideal key performance indicator of the two or more key performance indicators and the determined confidence level is specified.

14. The computer program product of claim 12, wherein sending the ideal key performance indicator method associated with the ideal key performance indicator, comprises program instructions, stored on the one or more computer readable storage media, which when executed by a processor, to:
determine, by one or more processors, two or more key performance indicator methods associated with two or more ideal key performance indicators meet the one or more application parameters; and
sending, by one or more processors, the two or more key performance indicator methods associated with the two or more ideal key performance indicators, wherein the ideal key performance indicator method of the two or more key performance indicator methods associated with the ideal key performance indicator is specified.

15. A computer system for managing methods for calculating key performance indicators, the computer system comprising:
one or more computer processors;
one or more computer readable storage media;
program instructions stored on the one or more computer readable storage media, for execution by at least one of the one or more computer processors, which when executed, to:
receive, by one or more processors, a plurality of key performance indicators for an activity measure, wherein each key performance indicator is associated with a key performance indicator method;
determine, by one or more processors, a corresponding confidence level for each of the plurality of key performance indicators;
identify, by one or more processors, an ideal key performance indicator based on the confidence level for each of the plurality of key performance indicators; and
receive a request, from an application, for information pertaining to the activity measure, wherein the request includes one or more application parameters related to the requested information.

16. The computer system of claim 15, further comprising program instructions, stored on the one or more computer readable storage media, which when executed by a processor, to:
identify, by one or more processors, the requested information is the ideal key performance indicator pertaining to the activity measure; and
sending, by one or more processors, the ideal key performance indicator and the determined corresponding confidence level to the requesting application.

17. The computer system of claim 15, further comprising program instructions, stored on the one or more computer readable storage media, which when executed by a processor, to:
identify, by one or more processors, the requested information is an ideal key performance indicator method associated with the ideal key performance indicator; and
sending, by one or more processors, the ideal key performance indicator method associated with the ideal key performance indicator.

18. The computer system of claim 16, wherein the one or more application parameters related to the requested information include a minimum threshold value for the confidence level for each key performance indicator.

19. The computer system of claim 17, wherein the one or more application parameters related to the requested information includes one or more of: an amount of time needed to calculate a key performance indicator, an amount of resources needed to calculate each key performance indicator, or a minimum threshold value for the confidence level of each key performance indicator.

20. The computer system of claim 17, wherein sending the ideal key performance indicator method associated with the ideal key performance indicator, comprises program instructions, stored on the one or more computer readable storage media, which when executed by a processor, to:
determine, by one or more processors, two or more key performance indicator methods associated with two or more ideal key performance indicators meet the one or more application parameters; and
sending, by one or more processors, the two or more key performance indicator methods associated with the two or more ideal key performance indicators, wherein the ideal key performance indicator method of the two or more key performance indicator methods associated with the ideal key performance indicator is specified.
